(19) United States
(12) Patent Application Publication
(10) Pub. No.: US 2026/0044928 A1
(43) Pub. Date: Feb. 12, 2026

(54) FDVIT: IMPROVE THE HIERARCHICAL ARCHITECTURE OF VISION TRANSFORMER

(71) Applicant: XILINX, INC., San Jose, CA (US)

(72) Inventors: Yixing XU, Beijing (CN); Chao LI, Beijing (CN); Dong LI, Beijing (CN); Xiao SHENG, Beijing (CN); Fan JIANG, Beijing (CN); Lu TIAN, Beijing (CN); Ashish SIRASAO, San Jose, CA (US)

(21) Appl. No.: 18/829,016

(22) Filed: Sep. 9, 2024

Related U.S. Application Data
(63) Continuation of application No. PCT/CN2024/111063, filed on Aug. 9, 2024.

(51) Int. Cl. G06T 3/4046; G06T 7/10

(52) U.S. Cl. CPC G06T 3/4046; G06T 7/10; G06T 2207/20021

(57) ABSTRACT

Embodiments herein relate to implementing a downsampling technique that uses a non integer stride, within the architecture of a vision transformer. Furthermore, embodiments herein relate to implementing a masked auto-encoder architecture to facilitate training the flexible, non integer stride downsampling layer. This reduces computational costs while increasing classification performance.

### CROSS REFERENCE TO RELATED APPLICATION

This application is a continuation of PCT Application No. PCT/CN2024/111063, filed on Aug. 9, 2024 of which is incorporated herein by reference in its entirety.

### TECHNICAL FIELD

Embodiments herein relate to vision transformers (ViTs) and convolutional neural networks (CNN) in the field of computer vision.

### BACKGROUND

Both CNNs and ViTs have advanced the field computer vision using different computational paradigms. CNNs excel in exploiting local spatial structures with their hierarchical feature extraction process, whereas ViTs leverage global self-attention to capture comprehensive contextual information. Both may be implemented to achieve the common goal of classifying images. CNNs and ViTs are two distinct architectures in the field of computer vision, each offering unique approaches to image analysis and understanding. CNNs can automatically and adaptively learn spatial hierarchies of features from images. They employ convolutional layers to perform localized filtering operations, which can capture local patterns such as edges, textures and shapes. ViTs, on the other hand, divide an image into a sequence of fixed-size patches where they are processed as a sequence of tokens. By employing self-attention mechanisms, each patch is attended to the other patches of the image, capturing intricate relationships and spatial dependencies.

However CNNs may struggle to capture long-range dependencies and global context due to their inherently local receptive fields. Additionally, the success of ViTs depends on large training datasets, as ViTs are challenging to optimize on smaller datasets and may be prone to overfitting, making them computationally expensive to implement. ViTs also lack inductive biases of local spatial structures, and can be challenging to optimize on smaller datasets. Additionally, ViTs may generate patches with high levels of similarity leading to computational inefficiencies due to redundant calculations. When multiple patches contain similar information, the self-attention mechanism processes these redundant patches separately, performing repetitive computations that do not contribute new information. This redundancy increases the overall computational cost and memory usage, making the model less efficient and slower, especially for larger scale images and datasets.

### SUMMARY

[COMPLETED AFTER CLAIMS ARE APPROVED]

### BRIEF DESCRIPTION OF DRAWINGS

FIG. 1 illustrates the architecture of a vision transformer implementing downsampling using a non integer stride, according to some embodiments.

FIG. 2 illustrates the transformer blocks of the vision transformer and a generated self-attending feature map, according to some embodiments.

FIG. 3 illustrates a flowchart describing the generation of a downsampled version of a generated feature map, according to some embodiments.

FIG. 4 illustrates downsampling using a non integer stride, according to some embodiments.

FIG. 5 illustrates a flowchart describing downsampling using a non integer stride, according to some embodiments.

FIG. 6 illustrates the overall architecture of a vision transformer implementing downsampling using a non integer stride, including training elements, according to some embodiments.

FIG. 7 illustrates training a non integer stride downsampling layer, according to some embodiments.

FIG. 8 illustrates a flowchart describing training a non integer stride downsampling layer, according to some embodiments.

### DETAILED DESCRIPTION

Embodiments herein relate to implementing a downsampling technique that uses a non integer stride, within a vision transformer architecture. Downsampling is a technique used in computer vision to reduce the resolution size of data while preserving the data's important features. This process help decrease the computational load, memory usage, and complexity management of subsequent processing steps. By summarizing or condensing the data, downsampling aids in highlighting prominent features and patterns, facilitating more efficient and effective analysis and modeling.

Implementing downsampling as a layer within a vision transformer architecture alleviates the challenge of a vision transformer generating patches with high levels of similarity, in turn, alleviating the computational inefficiencies of vision transformers due to redundant calculations. However, traditional integer stride downsampling methods shrink the spatial dimensions of data by at least half of their original size, overcompensating the challenges described, as traditional integer stride downsampling loses too much information for an accurate output to be generated by vision transformers.

Embodiments herein relate to implementing a flexible downsampling layer that is not limited to an integer stride. In other words, embodiments herein relate to implementing a downsampling technique that uses a non integer stride, within the architecture of a vision transformer. Furthermore, embodiments herein relate to implementing a masked auto-encoder architecture to facilitate training the flexible, non integer stride downsampling layer. This reduces computational costs while increasing classification performance.

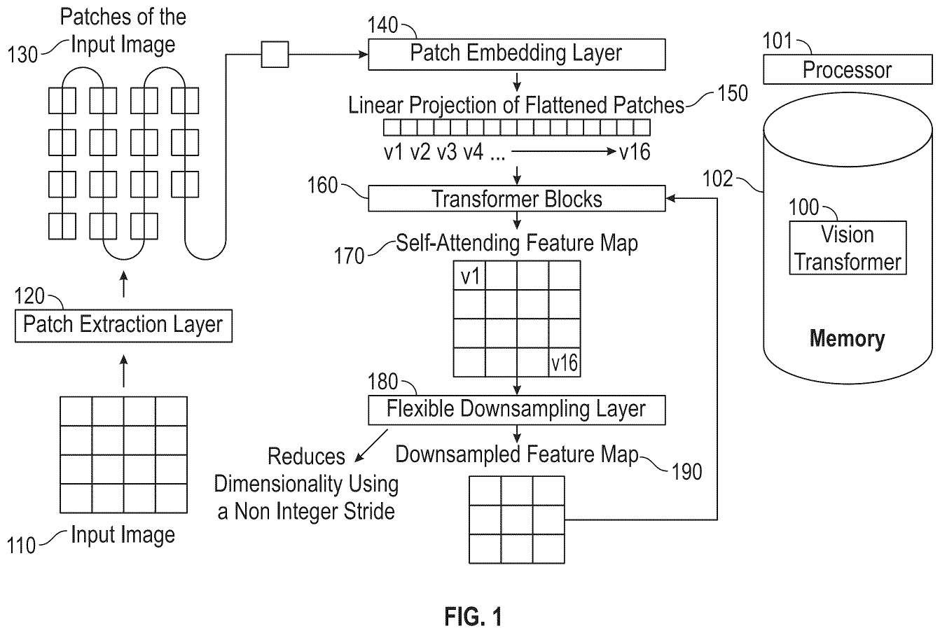

FIG. 1 illustrates the architecture of a vision transformer implementing downsampling using a non integer stride, according to some embodiments.

The vision transformer 100 can be implemented on a computing system with a processor 101, and a memory 102. The processor 101 generally retrieves and executes programming instructions stored in the memory 102. The processor 101 is representative of a single central processing unit (CPU), multiple CPUs, a single CPU having multiple processing cores, graphics processing units (GPUs) having multiple execution paths, specialized AI hardware accelerators (e.g., systems of a chip), and the like.

The memory 102 generally includes program code for performing various functions related to use of the vision transformer 100. The program code is generally described as various functional “applications” or “modules” within the memory 102, although alternate implementations may have different functions and/or combinations of functions. Within the memory 102, the vision transformer 100 facilitates non integer stride downsampling. This is discussed further, below.

A patch extraction layer 120 receives and input image 110. The patch extraction layer 120 divides the input image into a plurality of patches 130. The patches 130 represent different sections of the input image 110. A patch embedding layer 140 flattens each of the patches 130 and performs a linear or non-linear transformation on each flattened patch, creating a linear or non-linear projection of the flattened patches 150. A series of transformer blocks 160 transform the linear or non-linear projection of flattened patches 150 into feature vectors that are used to create a self-attending feature map 170. The flexible downsampling layer 180 reduces the dimensionality of the self-attending feature map 170 using a non integer stride, outputting the downsampled feature map 190.

The patch extraction layer 120 prepares the input image 110 for processing by the vision transformer architecture. The patch extraction layer divides the input image 110 into smaller, fixed-size patches. Each patch is then fed to the patch embedding layer where each patch is flattened into a one-dimensional vector (or a vector of another dimension). The vectors are then projected into a higher dimensional embedding space, creating the linear or non-linear projection of flattened patches 150.

For example, the input image 110 may be divided into patches of size 16×16 pixels at the patch extraction layer 120. An image of 224×224 pixels can be divided into 14λ14=196 patches. Each patch 130 is then received by the patch embedding layer 140 which flattens each patch 130 into a one dimensional vector. Following this example, the 16×16 pixel grid is converted into a 256-length vector. After flattening, each vector is linearly projected into a higher dimensional space, which may be done through a learnable linear transformation. In some embodiments, the vectors at this stage can be supplemented with positional encodings to retain information about spatial relationships between patches. These embeddings, which represent image patches, are fed to the transformer blocks 160.

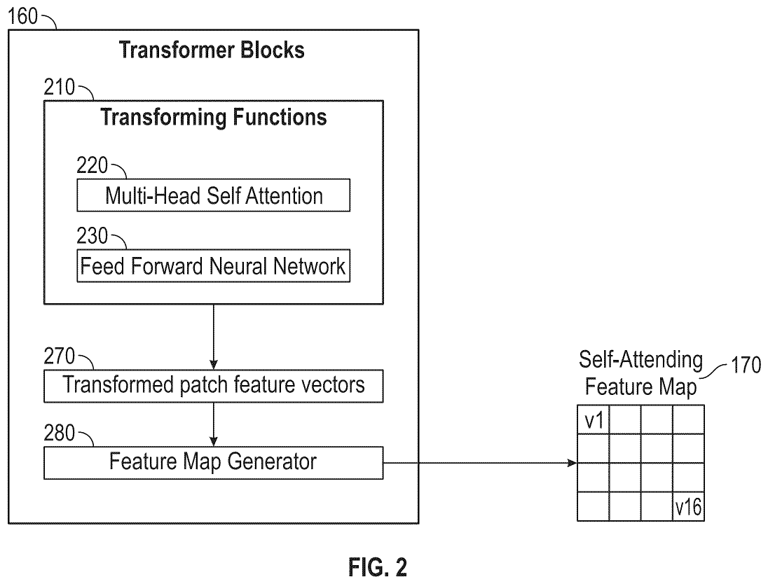

The transformer blocks 160 enable the model to process and understand the input image 110 using the linear or non-linear projection of flattened patches 150 to do so. The transformer blocks 160 may consist of multi-head self-attention layers and feed forward neural networks, among other mechanisms for capturing relationships and patterns within the image. This is discussed in further detail in FIG. 2.

The model can compute attention scores for each pair of patches in the image in the multi-head self-attention mechanism. This allows the model to weigh the importance of each patch in relation to others, effectively capturing long-range dependencies and contextual information. Multiple attention heads can operate in parallel, enabling the model to focus on different aspects of the patches simultaneously.

Following self-attention layers, their output can be passed through a feed-forward neural network. The feed-forward neural network may include two connected layers with a nonlinear activation function in between. This network can help further transform and refine the features extracted by the self-attention mechanism. The transformer blocks can also include residual connections and layer normalization steps for stabilizing and improving the learning process. Stacking multiple transformer blocks enables the vision transformer architecture to progressively build a comprehensive understanding of the image, integrating both local and global information to make accurate predictions.

The transformer blocks 160 are discussed in further detail in FIG. 2.

The output embeddings from the internal layers of the transformer blocks 160 represent the processed information of the image patches. The self-attending feature map 170 can be constructed from these embeddings by reshaping the embeddings and rearranging them back into a two-dimensional feature map that mirrors the original spatial arrangement of the patches as they were arranged in the input image 110. This self-attending feature map 170 retains the spatial structure of the original input image 110 while encapsulating high-level, context rich features learned by the internal layers of the transformer blocks 160.

The flexible downsampling layer 180 receives the self-attending feature map 170, reduces the dimensionality of the self-attending feature map 170 using a non integer stride, and outputs a downsampled feature map 190.

Downsampling refers to the process of reducing the spatial dimensions of feature maps, while preserving or summarizing the feature map's most important features. By reducing dimensionality and focusing on the most salient features of the data, the computational load for subsequent layers is decreased, memory usage is reduced, and efficiency is increased, among other benefits.

The flexible downsampling layer 180 downsamples the self-attending feature map 170 using a non integer stride. Non integer stride refers to a stride value used in downsampling operations that may not be a whole number. A stride defines the step size at which a convolving kernel moves across a feature map, reducing the size of the image in fixed increments. For example, a stride of 2 means the convolving kernel moves by 2 pixels or values at a time, resulting in a downsampled feature map of half the dimensionality of the original feature map. However, a non integer stride involves convolving kernel by fractional amounts, such as but not limited to, 1.5 pixels. Non integer stride downsampling can create a smoother and more continuous transition when resizing the feature map. Non integer stride downsampling can effectively capture more detailed information and maintain higher quality in the downsampled output.

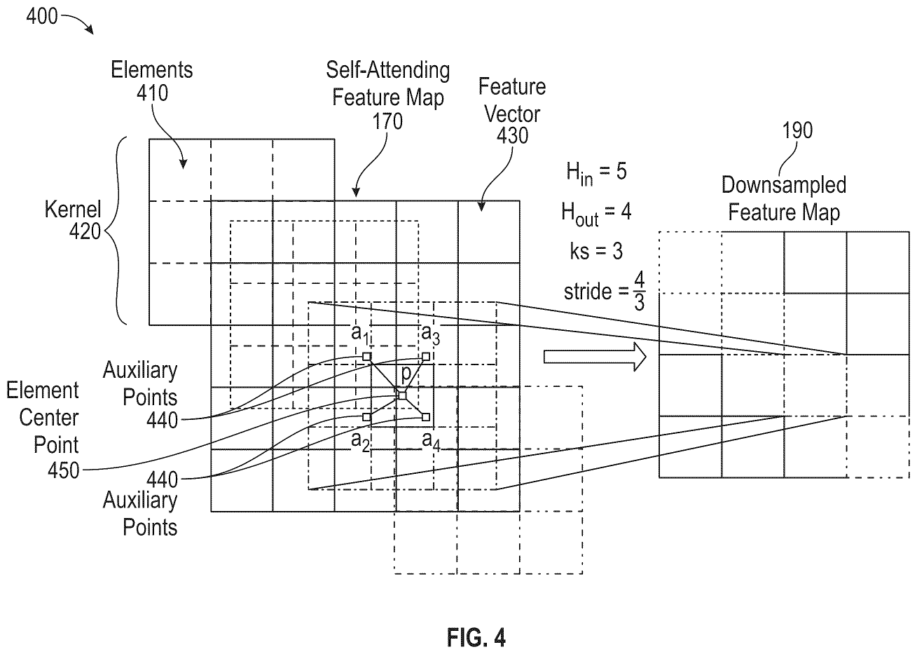

The flexible downsampling layer 180 and the formation of the downsampled feature map 190 are discussed in further detail in FIG. 4.

The downsampled feature map 190 refers to a reduced resolution representation of the self-attending feature map 170. The information contained in the self-attending feature map 170 has been condensed, while the most significant features have been retained due to operations implemented in the flexible downsampling layer 180.

In some embodiments, the downsampled feature map 190 may undergo further transforming through the transformer blocks 160. A new self-attending feature map of the dimensions of the downsampled feature map 190 may be outputted by the transformer blocks 160, and this new self-attending feature map may be downsampled, where its dimensionality is further reduced using a non integer stride, outputting a new downsampled feature map of a lower dimensionality. This process may repeat until a classification head is reached, outputting a classification for the input image 110.

FIG. 2 illustrates the transformer blocks 160 and example operations that may be performed within the transformer blocks so that the self-attending feature map 170 can be outputted. The transformer functions 210 may include but are not limited to a multi-head self-attention function 220, and a feed forward neural network function 230. Collectively, the transforming functions 210 within the transformer blocks 160 output transformed patch vectors 270 which are used by a feature map generator 280 to output the self-attending feature map 170.

Transforming functions 210 are primarily based on self-attention mechanisms, enabling vision transformer models to process and understand sequential data, such as the linear or non-linear projection of flattened patches 150, by capturing complex dependencies and relationships between elements in the sequence. By weighing the importance of each element in relation to others through attention scores and relationships derived from the transforming functions 210, the self-attending feature map 170 can be generated.

The multi-head self-attention 220 function of the transforming functions 210 enhances the vision transformer model's capability to capture diverse aspects of relationships and dependencies within the input data. The multi-head self-attention function 220 applies multiple self-attention mechanisms in parallel, with each of its own set of learnable parameters, to the same input sequence. This process can involve computing attention scores for each vector in the sequence relative to the other vectors, and allowing the transformer to focus on different parts of the input simultaneously, among other things. Each “head” or attention mechanism of the multi-head self-attention function 220 captures unique aspects of the input, such as various types of relationships or contextual information.

The multi-head self-attention function 220 can also aggregate a richer set of features and dependencies from the input data. By using multiple “heads” this transformer function can learn and represent different types of relationships, from local relationships to global relationships, within the data. This parallel processing enhances the model's capability to understand the patterns and interactions between the input data. Outputs from each attention head may be concatenated and linearly transformed, combining the diverse insights gained from different attention perspectives. This can result in a more comprehensive and nuanced representation of the input, improving the model's performance in image analysis tasks.

The feed-forward neural network (FFN) function 230 further transforms and refines the features extracted by the self-attention mechanisms of the transformer blocks 160. The FFN function 230 can include two connected or dense layers with a non-linear activation function, such as ReLU, applied between them. The FFN function 230 applies additional non-linear transformations to the attention enhanced features, enabling the model to capture even more complex patterns and relationships within the data.

The FFN function 230 can operate independently on each output of the multi-head self-attention function 220, meaning it can process each feature vector separately without considering the interactions between different positions. This ensures the model retains the rich position information learned from the multi-head self-attention function 220. The first dense layer of the FFN function 230 can expand the dimensionality of the feature vector to a higher dimensional space, creating new representations for the model to also learn.

The second dense layer of the FFN function 230 can reduce the dimensionality back to the original size, ensuring the output vector maintains the same dimensionality as the input. This sequence of transformations helps refine the features extracted by the multi-head self-attention function 220 enabling more discriminative and comprehensive representations of the input image to be derived.

The inclusion of the FFN function 230 in the transformer blocks enhances the model's capacity to understand more subtle and intricate patterns. The non-linear transformations applied by the FFN function 230 further push the model to perform at a higher level.

The transforming function 210 of the transformer blocks 160 are not limited to the multi-head self-attention function 220 and the FFN function 230.

The transforming functions 210 output transformed versions of the patch vectors received as input. The outputted transformed patch vectors 270 encapsulate the learned representations of the input image 110. The transformed patch vectors 270 collectively can form the self-attending feature map 170. The feature map generator 280 processes the outputted transformed patch vectors 270 such that their spatial relationships and rich feature representations are leveraged to produce the self-attending feature map 170.

The transformed patch vectors 270 contain learned representations of the respective inputted linear or non-linear projection of flattened patches 150, capturing both local features within the patches and global context due to applying the transformer functions 210. The number of transformed patch vectors 270 corresponds to the number of inputted flattened patches 150. The feature map generator 280 reshapes the vectors into a grid. The cells of the grid correspond to one of the inputted transformed patch vectors 270. Additionally, the feature map generator 280 represents the transformed patch vectors 270 in a suitable format for further process. For example, the feature map generator 280 can treat each of the transformed patch vectors 270 as a single point on a channel feature map of a different size. This results in a feature map of the dimensions of the grid by the number of channels. Each corresponding vector is placed on the corresponding position on the grid, forming the self-attending feature map 170, where the spatial layout reflects the original patch arrangement, and each location on the feature map contains the high dimensional vector representing the corresponding patch.

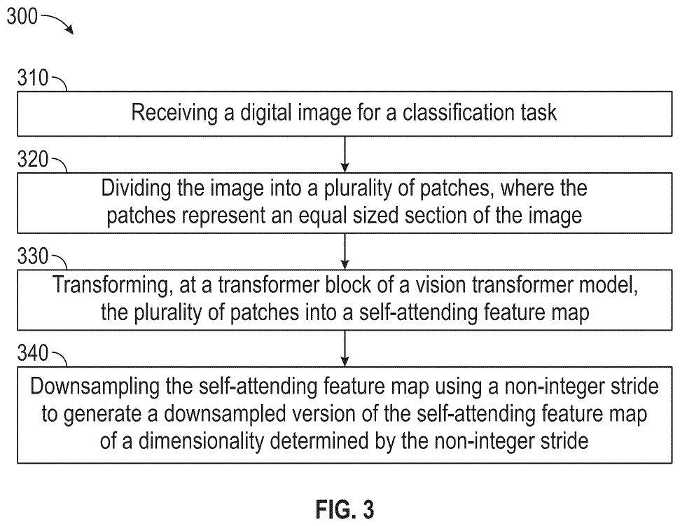

FIG. 3 illustrates a flowchart for generating a downsampled version of the self-attending feature map 170 using a non integer stride.

At block 310, the vision transformer system receives a digital image for a classification task. The digital image may be comprised of a grid of pixels, where each pixel represents a small portion of the image and holds color information. The arrangement of these pixels forms the overall image. In a color image, each pixel may contain, for example, three color channels: red, green, and blue (RGB). In one embodiment, each channel holds a numerical value representing the intensity of that color at that certain pixel location. The combination of different intensities in the RGB channels allows for the representation of a wide range of colors.

In addition to the pixel values, a digital image can also include metadata that provides additional information about the image such as the resolution (number of pixels in width and height), color depth (the number of bits used to represent the color of a single pixel), and sometimes details about how the image was captured or processed. This structured data enables digital images to be easily manipulated, analyzed, and displayed across various devices and platforms.

At block 320, the vision transformer system divides the input image into a plurality of patches, where, in one embodiment, the patches represent an equal sized section of the image. Dividing the input image refers to the process of splitting the digital image into smaller, fixed-size patches or segments. This enables the image to be managed and analyzed more effectively. The process begins by selecting a patch size, such as but not limited to 16×16 pixels. The image can then be semantically divided into patches of this size. Each patch captures a local region of the image, retaining the pixel values and structure within that area.

To achieve this division of the original input image, the input image may be overlaid with a grid, where each cell of the grid corresponds to a patch of the predefined size. For example, an image of size H×W with a patch size P×P results in (H/P)×(W/P) patches. Each patch, which may originally be a two-dimensional array of pixel values, may be flattened into a one-dimensional vector. Additionally, the flattened vectors can be linearly projected into a higher-dimensional space, resulting in patch embeddings. Positional encodings can be added to these embeddings to retain information about the patch's original position within the image. These transformations allow the data to be effectively handled by the transformer blocks of the vision transformer architecture, which operate on sequences of vectors. Additionally, this method allows the vision transformer model to process smaller, more manageable pieces of the image, facilitating parallel processing and enabling the extraction of both local and global features through subsequent layers.

At block 330, the vision transformer system transforms, at a transformer block, the plurality of patches into a self-attending feature map. After a plurality of transforming functions are performed on the inputted patches, the resulting transformed vectors contain self-attention information, among other encoded information regarding the significance of each patch in the context of the image. The transformed vectors can be reshaped to form a self-attending feature map. The transformed sequence of vectors can be reshaped into a grid, and the vectors can be stacked along the depth dimension to create a coherent self-attending feature map. Generating the self-attending feature map from the collection of transformed feature vectors involves reshaping the vectors into a spatial grid, forming a multi-dimensional tensor that retains both the local and global information encoded in the vectors. The structured self-attending feature map can be effectively utilized for various downstream tasks, such as downsampling, and later classification.

At block 340, the vision transformer system downsamples the generated self-attending feature map using a non integer stride to generate a downsampled version of the self-attending feature map of a dimensionality determined by the non integer stride.

In a hierarchical vision transformer system, downsampling serves to progressively reduce the spatial resolution of the self-attending feature map while increasing the feature map's semantic richness and abstraction. Downsampling enables the model to handle larger input images more efficiently and to build a hierarchy of features that range from fine-grained details to course high level representations.

By reducing the spatial dimensions of the feature maps, the vision transformer model can manage computational and memory tasks more effectively. Processing high resolution. Processing high-resolution images directly with fill resolution feature maps is computationally prohibitive. Downsampling allows the model to maintain a balance between detail and efficiency, enabling to scale to larger and more complex images. In one embodiment, downsampling facilitates the creation of multi-scale feature hierarchy. Early layers or iterations of the vision transformer model focus on capturing fine-grained, local details from the input image, while subsequent layers, operating on downsampled feature maps, capture more abstract, global features. This hierarchical representation is beneficial for tasks that benefit from understanding both local textures and global structures, such as object detection, segmentation, and image classification. By integrating features from different levels abstraction, the vision transformer model can achieve a more comprehensive understanding of the input image.

To prevent too much information from being lost at the downsampling stage of the vision transformer model, a non integer stride downsampling is implemented. Non integer stride downsampling reduce the spatial resolution of feature maps without adhering strictly to whole number strides. Fractional strides can be employed in a non integer stride downsampling technique, allowing for more nuanced and flexible control over the downsampling process, ensuring that not too much information is lost at this stage of the vision transforming process. In one embodiment, the non-integer stride is between 1 and 2.

For example, bilinear or bicubic interpolation method can be employed, where the feature map is resembled at intermediate points rather than fixed intervals. Another example is using transposed convolutions or fractional pooling operations, which allow the model to achieve the desired downsampling ratio while maintaining a smoother transition, and better preserving the spatial relationships within the feature map.

By using a non integer stride downsampling technique, more of the original information is retained than when using a strict integer stride technique. Finer control over the downsampling process allows the resulting downsampled self-attending feature map to keep more of the local details and textures from the original high resolution image input. This preservation improves the effectiveness of tasks that use high spatial fidelity, such as image segmentation and fine grained object recognition, among other things.

Additionally, the non integer stride downsampling produces a smoother transition between scales, reducing the risk of affects that can occur with a more abrupt method of downsampling. The smooth nature of downsampling using a non integer downsampling helps maintain the integrity of features, leading to better performing downstream tasks. A non integer stride downsampled feature vector can capture more nuanced patterns and relationships within the data, contributing to more accurate and robust predictions.

FIG. 4 illustrates the non integer stride downsampling technique used in the vision transformer model. In this illustration, the self-attending feature map 170 contains 5×5 feature vectors 430, and it is downsampled into a downsampled feature map 190 of 4×4 feature vectors. The values are depicted as Hᵢₙ=5, indicating the 5×5 self-attending feature map 170, and Hₒᵤₜ=4 indicting the 4×4 outputted downsampled feature map 190. The downsampled feature map 190 is generated as a kernel 420 convolves over the self-attending feature map 170, outputting a new feature vector representing the feature vectors the kernel 420 overlaps at the instance where the kernel 420 convolves over the self-attending feature map 170. In FIG. 4, the non integer stride is as 4/3. Stride represents the step interval in which the convolution or pooling operation moves the kernel 420 across the input feature map, such as the self-attending feature map 170. Stride controls the overlap between receptive fields and the downsampling rate, impacting both the computational efficiency and level of detailed preserved in the resulting downsampled feature map 190.

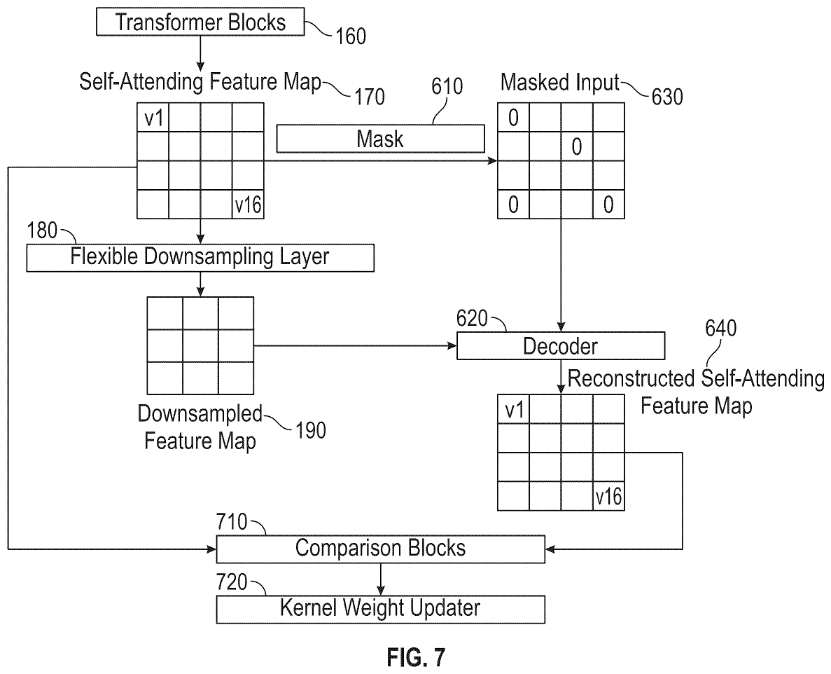

The kernel 420 contains 3×3=9 elements 410. In one embodiment, the kernel 420 is a small matrix of weights, where the weights are values established in each element 410 of the kernel 420. The weights of the elements 410 may initially be set randomly and then learned during the training process through back propagation. Training the weights of the elements 410 in each kernel 420 is described in further detail in FIG. 7. As the kernel 420 convolves over the self-attending feature map 170 with the non integer stride, it performs element-wise multiplications between the weights of the elements 410 and the input values of the feature vectors 430 the kernel 420 overlaps. These values may be summed to produce a single value in the outputted downsampled feature map 190. The kernel 420, which is smaller in size compared to the inputted self-attending feature map 170, convolves across the inputted self-attending feature map 170 with a certain non-integer stride (FIG. 4 illustrates four such convolutions). At each portion, the kernel 420 covers a portion of the input feature map. For each covered region, the element-wise product of the kernel's 420 weights and the input values of the feature vectors 270 is outputted.

Given an input Zᵢₙ∈ [symbol] ^{C}^{ᵢₙ}^{×H}^{ᵢₙ}^{×W}^{ᵢₙ} and a convolutional layer with filter F∈ [symbol] ^{K}^{ₕ}^{×K}^{_{w}}^{×C}^{ᵢₙ}^{×C}^{ₒᵤₜ}, the spatial size Hₒᵤₜ of the output feature map can be calculated as:

$${H}_{out} = \frac{{H}_{i n} - {K}_{h} + 2 {P}_{h}}{{S}_{h}} + 1$$

in which Kₕ, Pₕ and Sₕ are the kernel 420 size, padding and stride along the height dimension, and Cᵢₙ and Cₒᵤₜ are the number of input and output channels. The calculation along width dimension is similar to that of height and is ignored in the following. Non integer stride downsampling aims to smoothly reduce the spatial dimensions so more information can be kept at the earlier stages of the transformation process. The use of non-integer strides in the flexible downsampling layer 180 can output feature maps with arbitrary pre-defined size, Hₒᵤₜ. Specifically, given the input feature map size Hᵢₙ, we have:

$${\hat{S}}_{h} = \frac{{H}_{i n} - {K}_{h} + 2 {P}_{h}}{{H}_{out} - 1} .$$

Without loss of generality, one can define

$${P}_{h} = \frac{{K}_{h} - 1}{2}$$

and the output of the flexible downsampling layer 180 as:

$${Z}_{out} ( c , h , w ) = {\sum }_{i = [ - \frac{{K}_{h}}{2} ]}^{[ \frac{{K}_{h}}{2} ]} {\sum }_{j = [ \frac{{K}_{w}}{2} ]}^{[ \frac{{K}_{w}}{2} ]} {\sum }_{k = 1}^{{C}_{i n}} {Z}_{i n} ( k , h {\hat{S}}_{h} + i , w {\hat{S}}_{w} + j ) \times F ( i , j , k , c ) ,$$

in which Ŝₕ(Ŝ_{w}) is non-integer stride defined by

$${\hat{S}}_{h} = \frac{{H}_{i n} - {K}_{h} + 2 {P}_{h}}{{H}_{o u t} - 1} .$$

The values of input at non-integer coordinates are used to derive the output feature map. Thus, the value of point p=f(pₕ, p_{w}) at coordinate (pₕ, p_{w})∈ [symbol] ²₊ can be calculated with the help of four auxiliary points:

$${a}_{1} = f ( [ {p}_{h} ] , [ {p}_{w} ] ) ,$$

$${a}_{2} = f ( [ {p}_{h} ] , [ {p}_{w} ] ) ,$$

$${a}_{3} = f ( [ {p}_{h} ] , [ {p}_{w} ] ) ,$$

$${a}_{4} = f ( [ {p}_{h} ] , [ {p}_{w} ] ) ,$$

by gathering their information. Maxpooling p=max(aᵢ), average pooling p=mean (aᵢ), and the bilinear interpolation operation p=bilinear(aᵢ) i=1, . . . , 4 can be used to combine the four auxiliary points a₁, a₂, a₃, and a₄ to generate the value at point p, as depicted in FIG. 4. Thus, we can set Hₒᵤₜ=Hᵢₙ/α and Cₒᵤₜ=βCᵢₙ, and the data loss ratio after flexible downsampling layer 180 can be computed as:

$$\text{} \begin{matrix}{ℛ}_{d}^{′} = 1 - \frac{{Ω}_{o u t}^{′}}{{Ω}_{i n}} \\ = 1 - \frac{( β {C}_{i n} ) \times ( \frac{H}{α} ) \times ( \frac{W}{α} )}{{C}_{i n} \times H \times W} \\ = 1 - β - {α}^{2} .\end{matrix}$$

This downsampling using a non integer stride reduces the resolution of the self-attending feature map 170 but retains the essential features learned by the kernel 420. The larger the stride, the more aggressive the downsampling, leading to a more compact representation. Using a non integer stride allows for more control over the size of the downsampled feature map 190, leading to a more complete, yet compact representation of the input image 110, and ultimately, more accurate classification results with a reduced computational load.

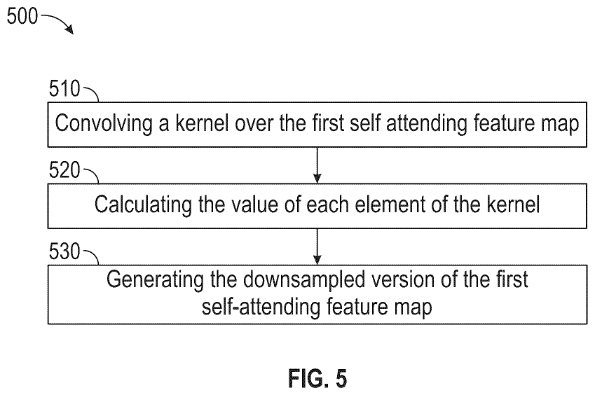

FIG. 5 illustrates a flowchart showing the non integer stride downsampling process.

At block 510, the kernel convolves over the inputted self-attending feature map. When a kernel convolves over a feature map, the kernel, which is a smaller matrix of weights, or parameters, systematically moves across the input feature map. At each position the kernel overlaps with the feature map at determined by the non integer stride values, element-wise multiplications are preformed between the kernel's weights and the corresponding input values of the feature map. Because of the non-integer stride, an element of the kernel (e.g., the element 410 in FIG. 4) does not precisely overlap with a feature vector of the feature map (e.g., the feature vector 430 in FIG. 4). As such, the resulting value for the feature map can be calculated using multiple feature vectors (where in FIG. 4 the value at point p is derived from the values a₁, a₂, a₃, and a₄ from the partially overlapping feature vectors. The resulting products can then be summed to produce a single value that becomes a part of the outputted downsampled feature map. The process is repeated as the kernel slides over the entire input feature map, generating the complete outputted downsampled feature map as discussed in FIG. 4.

At block 520, the vision transformer model, at the flexible downsampling layer, calculates the value of each element of the kernel. Calculating the value at each element of the kernel includes but is not limited to finding four auxiliary points (e.g., a₁, a₂, a₃, and a₄) located on four different feature vectors that the kernel overlaps, and determining their relationship to the center point of an element. Additional methods for gathering information to produce the downsampled feature map can be selected from maxpooling, average pooling, bilinear interpolation, etc.

At block 530, the flexible downsampling layer generates the downsampled version of the self-attending feature map. The downsampled feature map is a reduced resolution representation of the original feature map. The size of the feature map is decreased while the important features and patterns of the original feature map are maintained in the downsampled version with reduced dimensionality. The non integer stride downsampling is discussed in FIG. 4.

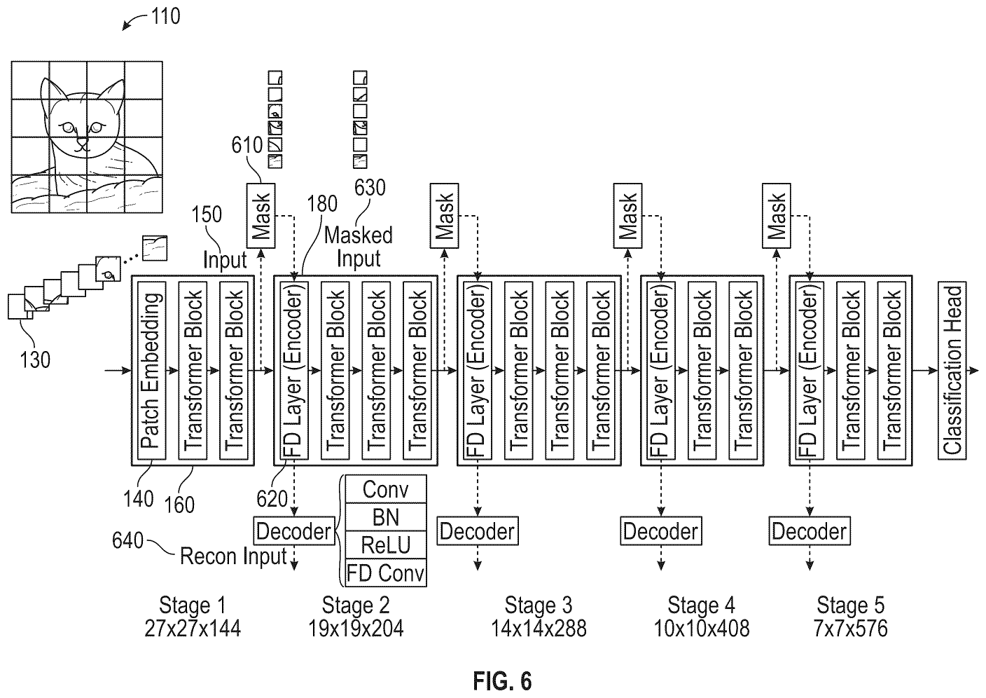

FIG. 6 illustrates the overall architecture of the vision transformer implementing the non integer stride downsampling. FIG. 6 includes modules for training the flexible downsampling layer 180. Training the flexile downsampling layer 180 involves using a mask 610, to mask the inputted linear or non-linear projection of flattened patches 150, and a decoder 620 that uses the masked input 630 and the outputted self-attending feature map 170 to produce a new, reconstructed self-attending feature map 640. More detail regarding the training process is discussed in FIG. 7.

Since the spatial dimensions are smoothly reduced, multiple flexible downsampling layers 180 for downsampling using a non integer stride may be implemented in this vision transformer architecture.

FIG. 7 illustrates the process for training the flexible downsampling layers 180 which are implemented within the vision transformer architecture.

The transformer blocks 160 output the intermediate, self-attending feature map 170, which is fed to the flexible downsampling layer 180 and downsampled using a non integer stride. The flexible downsampling layer 180 outputs the downsampled feature map 190. To train the flexible downsampling layer 180, adjusting the weights of the elements 410 of the kernel 420 appropriately, an auto encoder/decoder 620 architecture is implemented. The decoder 620 of this architecture receives the outputted downsampled feature map 190 from the flexible downsampling layer 180, and receives a masked input 630. The masked input 630 represents a “masked” or hidden version of the input data, being the self-attending feature map 170. This masking is done to prevent the model from accessing certain information from the originally inputted self-attending feature map 170, encouraging the model to learn dependencies and relationships based on the data available to the decoder 620. For example, the masked input 630 covers certain values of the self-attending feature map 170, as the mask 610 is applied to the self-attending feature map 170. The decoder uses the available data from the masked input 630, along with the downsampled feature map 190, to predict the masked values of the masked input 630 based on the context provided by the surrounding visible components of the masked input 630 and the downsampled feature map 190.

The mask 610 is a binary matrix or tensor that indicates which parts of the input self-attending feature map 170 should be hidden (masked) and what should be available (unmasked). In this binary matrix, the values 1 and 0 can denote masked or unmasked elements of the data. Masking data prevents the model from looking ahead while in training.

The use of masked inputs and masks allows models to be more robust and versatile, training models to understand context and predict missing components of the inputted data.

The reconstructed self-attending feature map 640 outputted by the decoder 620 is then compared to the original self-attending feature map 170 at the comparison blocks 710. The comparison blocks 710 may use comparison factors such as comparing the loss value, or the mean squared error, and then updating the element 410 weights of the kernels 420 at the kernel weight updater 720.

For flexible downsampling layers 180, the original input Iᵢₙ is used for subsequent layers to generate the classification output, and the masked input

$${I}_{i n}^{M r}$$

is used as the input of auto-encoder/decoder 620 architecture to further help flexible downsampling layers 180 generate informative downsampled feature maps 190. The mainstream network and the masked auto-encoder/decoder 620 architecture are learned through an end-to-end training method by back-propagating the final loss function which combines the ordinary classification loss with the proposed reconstruction loss

$$ℒ = {ℒ}_{c} + \frac{θ}{S} {\sum }_{S} {ℒ}_{recon}^{{M}_{r}^{S}}$$

in which S is the number of flexible downsampling layers 180, [symbol] =ΣH_{cross}(y, y_{gt}) is the cross-entropy loss for classification and θ is the trade-off parameter.

Downsampling reduces the similarity of patches and derives compact feature maps, which copes well with the purpose of auto-encoder/decoder 620 to generate compact features from the original inputted self-attending feature map 170. Thus, besides training downsampling layers through an end-to-end manner with classification loss, the auto-encoder/decoder 620 architecture facilitates the training of flexible downsampling layers 180 and generates informative output after downsampling. For example, given the input Iᵢₙ∈ [symbol] ^{C}^{ᵢₙ}^{×H}^{ᵢₙ}^{×W}^{ᵢₙ}, the flexible downsampling layers 180 are treated as an encoder that derives the middle output, or the self-attending feature map 170

$${I}_{mid} = E ( {I}_{i n} ) ∈ {ℝ}^{β {C}_{i n} \times ( {H}_{i n} / α ) \times ( \frac{{W}_{i n}}{α} )} ) ,$$

in which E(⋅) is the operation introduced in

$${Z}_{out} ( c , h , w ) = {\sum }_{i = [ - \frac{{K}_{h}}{2} ]}^{[ \frac{{K}_{h}}{2} ]} {\sum }_{j = [ \frac{{K}_{w}}{2} ]}^{[ \frac{{K}_{w}}{2} ]} {\sum }_{k = 1}^{{C}_{i n}} {Z}_{i n} ( k , h {\hat{S}}_{h} + i , w {\hat{S}}_{w} + j ) \times F ( i , j , k , c ) .$$

Then, I_{mid} is sent to the decoder:

$${I}_{o u t} = D ( {I}_{m i d} ) = FDConv 2 ( ReLU ( BN ( Conv1 ( {I}_{mid} ) ) ) ) ,$$

in which BN is the batch normalization, ReLU is the nonlinear activation function, Conv1 is the traditional convolutional layer that maps the channel dimension from βCᵢₙ to Cᵢₙ and FDConv2 maps the spatial dimension from (Hᵢₙ/α)

$$( \frac{{W}_{i n}}{α} )$$

to (Hᵢₙ)(Wᵢₙ) by using non-integer stride 1/α. The auto-encoder/decoder 620 is trained by minimizing the mean squared error between the input Iᵢₙ and the output Iₒᵤₜ:

$${ℒ}_{recon} = \frac{1}{n} {\sum }_{i = 1}^{n} {( {I}_{o u t} - {I}_{i n} )}^{2}$$

in which n is the number of samples.

With this baseline encoder/decoder 620 structure, a mask 610 is also applied on the inputted self-attending feature map 170 enabling the decoder 620 to generalize better. For example, given the input, Iᵢₙ, a binary mask Mᵣ∈{0, 1}^{C}^{ᵢₙ}^{×H}^{ᵢₙ}^{×W}^{ᵢₙ}, is multiplied on Iᵢₙ and derives the masked input

$${I}_{o u t}^{{M}_{r}} = {I}_{i n} ⊙ {M}_{r} ,$$

in which r=|Mᵣ(m=0)|/|Mᵣ| is defined as the masking ratio with |Mᵣ(m=0)| indicates the number of 0's in the binary mask and |Mᵣ| is the total number of elements in My. The output of the masked auto-encoder/decoder 620 is generated based on the masked input

$${I}_{o u t}^{{M}_{r}} = D ( E ( {I}_{i n}^{{M}_{r}} ) ) ,$$

and the reconstruction loss is applied to the output and the original input:

$${ℒ}_{recon}^{{M}_{r}} = \frac{1}{n} {\sum }_{i = 1}^{n} {( {I}_{o u t}^{{M}_{r}} - {I}_{o u t}^{{M}_{r}} )}^{2}$$

where the masking ratio r controls the difficulty of this task. The mask and the decoder 620 architecture are used during training, and do not have an effect on the inference process.

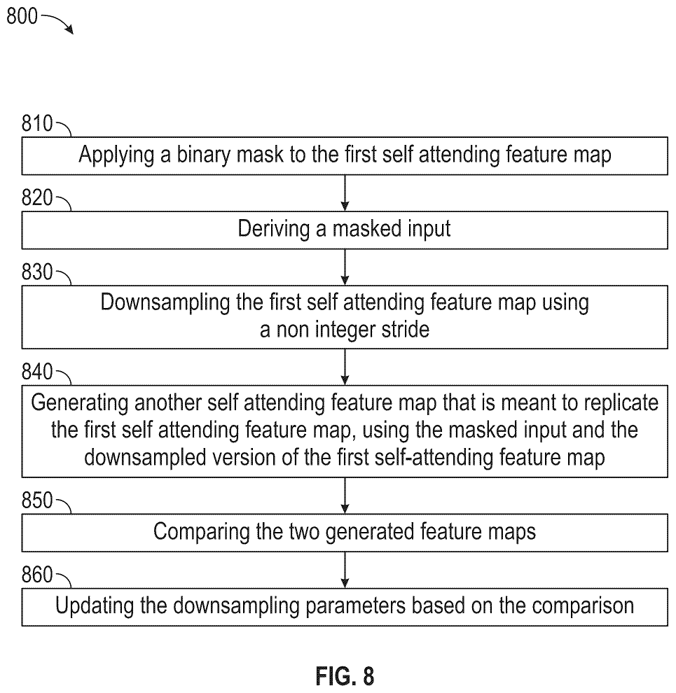

FIG. 8 illustrates a flowchart describing the training process.

At block 810, the vision transformer model applies a binary mask to the inputted self-attending feature map. Applying a binary mask to input data involves selectively concealing certain patches of the inputted self-attending feature map. This binary mask is a matrix where each element corresponds to a vector in the self-attending feature map. The value of one or zero indicates whether the patch is hidden or visible.

At block 820, the binary mask derives a masked input. When the mask is applied, the model ignores the information from the masked feature vectors and processes the unmasked feature vectors. This enables decoder to predict the content of the masked feature vectors based on the context provided by the unmasked feature vectors, improving the model's ability to learn spatial relationships and dependencies within the image.

At block 830, the flexible downsampling layer downsamples the inputted self-attending feature map using a non integer stride. As discussed in FIG. 4, downsampling using a non integer stride involves reducing the spatial resolution of the feature map in a more gradual and flexible manner compared to using an integer stride. Non integer stride allows for fractional movements. This approach retains more of the original image information and spatial details, resulting in smoother and less abrupt transitions in the downsampled feature map. By capturing more nuanced variations and preserving finer details, non integer stride downsampling provides and balanced way to reduce computational complexity while maintaining the integrity and richness of the visual features.

At block 840, the decoder generates another self-attending feature map that is meant to replicate the first self-attending feature map, using the masked input and the downsampled version of the first self-attending feature map. The decoder uses the masked input data and the downsampled version of the first self-attending feature map to generate a reconstructed, or replicated version of the first inputted self-attending feature map by utilizing the contextual information of the downsampled feature map. The goal of the decoder is to fill in the masked regions of the masked input data based on the patterns and structures learned from the visible parts of the input, thereby reconstructing a complete and accurate representation of the original data.

At block 850, the model compares the two self-attending feature maps. Comparing the decoder's reconstructed feature map to the original inputted feature map involves evaluating how accurately the decoder has reconstructed the masked regions. The comparison can performed using a loss function, such as the mean squared error loss function, which provides a measure of the reconstruction error indicating how close the predicted feature map is to the originally inputted self-attending feature map. By minimizing the mean squared error during training, the model learns to generate more accurate reconstructions, improving its ability to predict missing parts of the input data based in the context provided by the unmasked regions.

At block 860, the model updates the parameters, or weights, used to downsample based on the comparison. The parameters of the kernel used to generate the downsampled feature map can be updated through a backpropagation process combined with gradient descent. During the forward pass, the kernel convolves with the input data to produce the feature map, and a loss function, such as mean squared error, calculates the discrepancy between the predicted feature map and the original inputted self-attending feature map. In the backward pass, backpropagation computes the gradients of the the loss with respect to each weight of each element of the kernel, indicating how changes in the weights would affect the loss. Using these gradients, the weights or parameters are then adjusted in the opposite direction of the gradient, which may be done via gradient descent. This reduces the loss. This iterative process of forward pass, loss calculation, backpropagation, and weight or parameter update continues across multiple training cycles, gradually optimizing the kernel's parameters to minimize the prediction error and improve the model's performance.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
receiving a digital image for a classification task;
dividing the image into a plurality of patches;
transforming, at a transformer block of a vision transformer model, the plurality of patches into a self-attending feature map; and
downsampling the self-attending feature map using a non-integer stride to generate a downsampled version of the self-attending feature map of a dimensionality determined by the non-integer stride.

2. The method of claim 1, further comprising:
transforming the downsampled version of the self-attending feature map into a plurality of feature vectors;
generating a second self-attending feature map using the plurality of feature vectors;
downsampling the second self-attending feature map using a non-integer stride; and
generating a downsampled version of the second self-attending feature map of a dimensionality determined by the non-integer stride, wherein the dimensionality becomes smaller with each downsampling operation performed.

3. The method of claim 1, wherein downsampling the first self-attending feature map is a trained process, wherein the training comprises:
receiving the self-attending feature map;
applying a binary mask to the first self-attending feature map, wherein applying the binary mask derives a masked input;
downsampling the first self-attending feature map using a non-integer stride;
generating a downsampled version of the first self-attending feature map of a dimensionality determined by the non-integer stride;
generating a third self-attending feature map, wherein the third self-attending feature map is meant to replicate the first self-attending feature map using the masked input and the downsampled version of the first self-attending feature map;
comparing the third self-attending feature map to the first self-attending feature map; and
updating, based on the comparison, parameters used to downsample using the non integer stride.

4. The method of claim 3, wherein the third self-attending feature map is generated by applying at least one of:
a batch normalization function,
a nonlinear activation function,
a mapping function for spatial dimension, or
a mapping function for channel dimension to the first self-attending feature map.

5. The method of claim 3, wherein the parameters are kernel weights that are adjusted by minimizing mean squared error between the first self-attending feature map and the generated third self-attending feature map.

6. The method of claim 1, wherein downsampling using a non integer stride comprises:
convolving a kernel, wherein the kernel contains a plurality of elements, over the first self-attending feature map according to the non integer stride;
calculating a value of each element of the kernel, wherein calculating the value comprises:
determining four auxiliary points in relation to the center point of each element, wherein each of the four points is located on a feature vector of the self-attending feature map where the kernel overlaps; and
deriving the value for each element using the four auxiliary points corresponding a point on the element; and
generating the downsampled version of the first self-attending feature map based on the value for each element.

7. The method of claim 6, wherein deriving the value for each element using the four auxiliary points is done by at least one of:
maxpooling,
average pooling, or
bilinear interpolation.

8. The method of claim 1, wherein transforming each patch into a feature vector comprises applying a plurality of computer vision transforming functions to each patch, wherein each patch is transformed according to the transforming functions.

9. The method of claim 1 further comprising:
reshaping each patch into a one-dimensional vector; and
projecting the one-dimensional vectors into a new space.

10. The method of claim 1 wherein the non integer stride value is less than 2.

11. A system comprising:
one or more processors; and
one or more memories configured to store an application, which, when executed by a combination of the one or more processors, causes the combination of the one or more processors to perform an operation, the operation comprising:
receiving a digital image for a classification task;
dividing the image into a plurality of patches;
transforming, at a transformer block of a vision transformer model, the plurality of patches into a self-attending feature map; and
downsampling the self-attending feature map using a non-integer stride to generate a downsampled version of the self-attending feature map of a dimensionality determined by the non-integer stride.

12. The system of claim 11, further comprising:
transforming the downsampled version of the self-attending feature map into a plurality of feature vectors;
generating a second self-attending feature map using the plurality of feature vectors;
downsampling the second self-attending feature map using a non-integer stride; and
generating a downsampled version of the second self-attending feature map of a dimensionality determined by the non-integer stride, wherein the dimensionality becomes smaller with each downsampling operation performed.

13. The system of claim 11, wherein downsampling the first self-attending feature map is a trained process, wherein the training comprises:
receiving the self-attending feature map;
applying a binary mask to the first self-attending feature map, wherein applying the binary mask derives a masked input;
downsampling the first self-attending feature map using a non-integer stride;
generating a downsampled version of the first self-attending feature map of a dimensionality determined by the non-integer stride;
generating a third self-attending feature map, wherein the third self-attending feature map is meant to replicate the first self-attending feature map using the masked input and the downsampled version of the first self-attending feature map;
comparing the third self-attending feature map to the first self-attending feature map; and
updating, based on the comparison, parameters used to downsample using the non integer stride.

14. The system of claim 13, wherein the third self-attending feature map is generated by applying at least one of:
a batch normalization function,
a nonlinear activation function,
a mapping function for spatial dimension, or
a mapping function for channel dimension to the first self-attending feature map.

15. The system of claim 13, wherein the parameters are kernel weights that are adjusted by minimizing mean squared error between the first self-attending feature map and the generated third self-attending feature map.

16. The system of claim 11, wherein downsampling using a non integer stride comprises:
convolving a kernel, wherein the kernel contains a plurality of elements, over the first self-attending feature map according to the non integer stride;
calculating a value of each element of the kernel, wherein calculating the value comprises:
determining four auxiliary points in relation to the center point of each element, wherein each of the four points is located on a feature vector of the self-attending feature map where the kernel overlaps; and
deriving the value for each element using the four auxiliary points corresponding to a point on the element; and
generating the downsampled version of the first self-attending feature map based on the value of each element.

17. The system of claim 11, wherein transforming each patch into a feature vector comprises applying a plurality of computer vision transforming functions to each patch, wherein each patch is transformed according to the transforming functions.

18. The system of claim 11 further comprising:
reshaping each patch into a one-dimensional vector; and
projecting the one-dimensional vectors into a new space.

19. The system of claim 11 wherein the non integer stride value is less than 2.

20. A computer-readable storage medium having computer-readable program code embodied therewith, the computer-readable program code executable by one or more computer processors to:
receive a digital image for a classification task;
divide the image into a plurality of patches;
transform, at a transformer block of a vision transformer model, the plurality of patches into a self-attending feature map; and
downsample the self-attending feature map using a non-integer stride to generate a downsampled version of the self-attending feature map of a dimensionality determined by the non-integer stride.
